(19) United States
(12) Patent Application Publication
(10) Pub. No.: US 2013/0241805 A1
(43) Pub. Date: Sep. 19, 2013

(54) Using Convergence Angle to Select Among Different UI Elements

(71) Applicant: Luis Ricardo Prada Gomez, Hayward, CA (US)

(72) Inventor: Luis Ricardo Prada Gomez, Hayward, CA (US)

(73) Assignee: GOOGLE INC., Mountain View, CA (US)

(21) Appl. No.: 13/566,494

(22) Filed: Aug. 3, 2012

Related U.S. Application Data
(60) Provisional application No. 61/611,188, filed on Mar. 15, 2012.

(51) Int. Cl. G09G 5/00

(52) U.S. Cl. 345/8

(57) ABSTRACT

A wearable computing system may include a head-mounted display (HMD). The HMD could be configured to present a field of view that could include views of the real world environment as well as displayed images. As the viewer attempts to see objects at different real or apparent depths within the field of view, the brain may generally coordinate the eyes to jointly change a vergence angle. If the depth is known (because it may be generated by a user interface (UI)) and the user is wearing an eye-tracking system, it is possible to determine at which of the objects the user intends to look. This may allow the interface to place UI elements in locations that are perceived to be very close, or even overlapping, while the wearer may able to discriminate the object of interest, which is generally not possible with non-stereoscopic displays.

### CROSS-REFERENCE TO RELATED APPLICATIONS

This application claims priority to U.S. Provisional Patent Application Ser. No. 61/611,188 filed Mar. 15, 2012, the contents of which are hereby incorporated by reference.

### BACKGROUND

Wearable systems can integrate various elements, such as miniaturized computers, input devices, sensors, detectors, image displays, wireless communication devices as well as image and audio processors, into a device that can be worn by a user. Such devices provide a mobile and lightweight solution to communicating, computing and interacting with one's environment. With the advance of technologies associated with wearable systems and miniaturized optical elements, it has become possible to consider wearable compact optical displays that augment the wearer's experience of the real world.

By placing an image display element close to the wearer's eye(s), an artificial image can be made to overlay the wearer's view of the real world. Such image display elements are incorporated into systems also referred to as “near-eye displays”, “head-mounted displays” (HMDs) or “heads-up displays” (HUDs). Depending upon the size of the display element and the distance to the wearer's eye, the artificial image may fill or nearly fill the wearer's field of view.

### SUMMARY

In a first aspect, a wearable computing device is provided. The wearable computing device includes a head-mounted display (HMD). The HMD is configured to display images. The images are viewable from at least one of a first viewing location or a second viewing location. The wearable computing device further includes at least one infrared light source. The infrared light source is configured to illuminate at least one of the first viewing location or the second viewing location with infrared light such that the infrared light is reflected from the at least one illuminated viewing location as reflected infrared light. The wearable computing device further includes at least one camera. The at least one camera is configured to acquire at least one image of the at least one illuminated viewing location by collecting the reflected infrared light. The wearable computing device further includes a computer. The computer is configured to determine a vergence angle based on the at least one image of the at least one illuminated viewing location, determine a gaze point based on the vergence angle, select an image based on the gaze point, and control the HMD to display the selected image.

In a second aspect, a method is provided. The method includes optically determining a first gaze direction and a second gaze direction within a field of view provided by a head-mounted display (HMD). The HMD is configured to display images within the field of view. The method further includes determining a gaze point based on a vergence angle between the first and second gaze directions. The method further includes selecting a target object from the images based on the gaze point and a depth of the target object.

In a third aspect, a method is provided. The method includes optically determining a first gaze direction and a second gaze direction within a field of view provided by a head-mounted display (HMD). The HMD is configured to display images within the field of view. The method further includes determining a gaze point based on a vergence angle between the first and second gaze directions. The method further includes adjusting the images based on the gaze point.

In a fourth aspect, a non-transitory computer readable medium is provided. The non-transitory computer readable medium has stored therein instructions executable by a computing device that cause the computing device to perform functions, including: (1) causing a head-mounted display (HMD) to acquire images of first and second viewing locations, wherein the HMD is configured to display images; (2) determining a first gaze direction and a second gaze direction based on the images of the first and second viewing locations; (3) determining a gaze point based on a vergence angle between the first and second gaze directions; and (4) selecting a target object from the images based on the gaze point and a depth of the target object.

### BRIEF DESCRIPTION OF THE DRAWINGS

FIG. 1 is a schematic diagram of a wearable computing device, in accordance with an example embodiment.

FIG. 2A is a perspective view of a head-mounted display, in accordance with an example embodiment.

FIG. 2B is a perspective view of a head-mounted display, in accordance with an example embodiment.

FIG. 2C is a perspective view of a head-mounted display, in accordance with an example embodiment.

FIG. 3A is a side view of an eye-tracking system with a forward gaze direction, in accordance with an example embodiment.

FIG. 3B is a side view of the eye-tracking system of FIG. 3A with an upward gaze direction, in accordance with an example embodiment.

FIG. 4A is a real-world scene, in accordance with an example embodiment.

FIG. 4B is a real-world scene of FIG. 4A, in accordance with an example embodiment.

FIG. 4C is a real-world scene of FIG. 4A and FIG. 4B, in accordance with an example embodiment.

FIG. 5 is a flowchart of a method, in accordance with an example embodiment.

FIG. 6 is a flowchart of a method, in accordance with an example embodiment.

### DETAILED DESCRIPTION

In the following detailed description, reference is made to the accompanying figures, which form a part thereof. In the figures, similar symbols typically identify similar components, unless context dictates otherwise. The illustrative embodiments described in the detailed description and figures are not meant to be limiting. Other embodiments may be utilized, and other changes may be made, without departing from the spirit or scope of the subject matter presented herein. It will be readily understood that the aspects of the present disclosure, as generally described herein, and illustrated in the figures, can be arranged, substituted, combined, separated, and designed in a wide variety of different configurations, all of which are contemplated herein.

1. Overview

A head-mounted display (HMD) may enable its wearer to observe the wearer's real-world surroundings and also view a displayed image, such as a computer-generated image. In some cases, the displayed image may overlay a portion of the wearer's field of view of the real world. Thus, while the wearer of the HMD is going about his or her daily activities, such as walking, driving, exercising, etc., the wearer may be able to see a displayed image generated by the HMD at the same time that the wearer is looking out at his or her real-world surroundings.

The displayed image, which could be a virtual image, might include, for example, graphics, text, and/or video. The content of the displayed image could relate to any number of contexts, including but not limited to the wearer's current environment, an activity in which the wearer is currently engaged, the biometric status of the wearer, and any audio, video, or textual communications that have been directed to the wearer. The images displayed by the HMD may also be part of an interactive user interface. For example, the HMD could be part of a wearable computing device. Thus, the images displayed by the HMD could include menus, selection boxes, navigation icons, or other user interface features that enable the wearer to invoke functions of the wearable computing device or otherwise interact with the wearable computing device.

The images displayed by the HMD could appear anywhere in the wearer's field of view. For example, the displayed image might occur at or near the center of the wearer's field of view, or the displayed image might be confined to the top, bottom, or a corner of the wearer's field of view. Alternatively, the displayed image might be at the periphery of or entirely outside of the wearer's normal field of view. For example, the displayed image might be positioned such that it is not visible when the wearer looks straight ahead but is visible when the wearer looks in a specific direction, such as up, down, or to one side. In addition, the displayed image might overlay only a small portion of the wearer's field of view, or the displayed image might fill most or all of the wearer's field of view. The displayed image could be displayed continuously or only at certain times (e.g., only when the wearer is engaged in certain activities).

The displayed images may appear fixed relative to the wearer's environment. For instance, the images may appear anchored to a particular object or location within the wearer's environment. Alternatively, displayed images may appear fixed relative to the wearer's field of view. For example, the HMD may include a graphical user interface (GUI) that may stay substantially anchored to the wearer's field of view regardless of the HMD orientation. Both types of imagery may be implemented together within the context of the current disclosure.

To display an image to the wearer, an optical system in the HMD may include a light source, such as a light-emitting diode (LED), that is configured to illuminate a display panel, such as a liquid crystal-on-silicon (LCOS) display. The display panel generates light patterns by spatially modulating the light from the light source, and the light patterns may be viewable as images at a viewing location.

The HMD may obtain data from the wearer in order to perform certain functions, for instance to provide context-sensitive images to the wearer. In an example embodiment, the HMD may obtain information regarding the wearer and the wearer's environment and respond accordingly. For instance, the HMD may use a pupil position recognition technique, wherein if the HMD recognizes that the wearer's pupil location, and thus a corresponding gaze axis, is inclined with respect to a reference axis, the HMD may display images related to objects located above the wearer. Alternatively, the HMD may recognize, by a similar pupil position recognition technique, that the wearer is looking downward. Accordingly, the HMD may display images related to objects located below a reference axis of the wearer.

In order to determine the actual position of a HMD wearer's pupil and to determine a corresponding gaze axis, the wearer's pupil may be illuminated by an infrared light source or multiple infrared light sources. An infrared camera may image the pupil and other parts of the HMD wearer's eye. The infrared light source(s) could be located in the HMD optical path, or could alternatively be located off-axis. The infrared camera could also be located in the HMD optical path or off-axis. Possible eye tracking modalities that could be used include dark pupil imaging and dual-glint Purkinje image tracking, among other techniques known in the art.

A processor may implement an image processing algorithm to find the edges or extents of the imaged pupil. The image processing algorithms may include pattern recognition, Canny edge detection, thresholding, contrast detection, or differential edge detection, to name a few. Those skilled in the art will understand that a variety of different image processing techniques could be used individually or in combination with other methods in order to obtain pupil location. After image processing, the processor may determine a gaze axis, which may be defined as an axis extending from a viewing location and through a gaze point located within the wearer's field of view.

A HMD can present a field of view to one eye or to both eyes of a HMD wearer. The field of view could include views of the real world environment as well as displayed images that could be presented to one or both eyes. The HMD may display the images at various apparent distances relative to each eye of the a wearer in order, for instance, to give the illusion that objects are in different distance planes relative to the wearer. As the HMD wearer attempts to see each of these objects, the brain generally coordinates the eyes to jointly change a vergence angle, which can be defined as the angle made by two intersecting gaze axes.

By tracking the gaze axis of both eyes of an HMD wearer, the vergence angle could be determined when the HMD wearer focuses upon an object in the real-world environment or when the HMD wearer attempts to view images displayed by the HMD. In this way, a distance plane at which the HMD wearer is gazing could be determined.

If a depth of the displayed images is known, for instance because the display of images may be controlled by a user interface (UI), and the HMD wearer is using an eye-tracking system, it may be possible to identify at which of the objects the user is gazing. This may allow the placement of UI elements in display locations that are perceived to be very close, or even overlapping, while the wearer may be able to discriminate an object of interest in the set of displayed images.

Further, images may be adjusted to correspond to the determined distance plane, for instance to appear as in-focus text information while viewing a target object. The images may also be displayed at other distance planes to give the effect of an apparent ‘background’ or ‘foreground’. Such images could be displayed, for instance, to present a three-dimensional augmented reality to an HMD wearer.

Vergence angle could also be determined in order to select a target object within a field of view of a HMD wearer. For instance, an HMD wearer may be looking around a real-world scene and may fixate upon an object. The HMD wearer's eyes may individually align with the object and have respective gaze axes. The eye-tracking system may determine the wearer's gaze axes and a combined vergence angle. The vergence angle could be defined as the (generally smaller) angle defined between the two gaze axes of the HMD user's eyes. From this information, a computer may determine a wearer's gaze point, or the place in three-dimensional space at which the HMD wearer is gazing. In such a manner, a target object (in the form of an image or real-world object) could be selected.

In addition, determining a gaze axis for both eyes (and thus determining a vergence angle) can be used to disambiguate potential target objects. For instance, in an office environment, it may be difficult to determine whether a HMD wearer is looking at a pane of glass or a computer monitor beyond it. By determining a gaze depth and/or gaze point based on the vergence angle, the two situations can be disambiguated. Thus, image adjustment and/or the selection of real-world target objects could be more reliably performed.

In practice, vergence measurements may be useful when gazing at objects or displayed images within a range of about 3 meters. Outside of that range, vergence measurements may be less accurate at determining gaze depth and gaze point. Accordingly, the HMD may use other means to estimate the gaze depth and gaze point if the HMD determines that the target object/gaze depth may lie outside approximately 3 meters.

It will be evident to those skilled in the art that there are a variety of ways to implement such a method for vergence determination and subsequent target object selection or image adjustment/selection in a HMD system. The details of such implementations may depend on, for example, the type of data provided to the HMD, the local environmental conditions, the location of the user, and the task to be performed.

Certain illustrative examples of using eye-tracking data to determine eye gaze vergence so as to select target objects and to adjust images displayed by a HMD are described below. It is to be understood, however, that other embodiments are possible and are implicitly considered within the context of the following example embodiments.

2. Head-Mounted Display (HMD) with Eye-Tracking System for Vergence Angle Determination

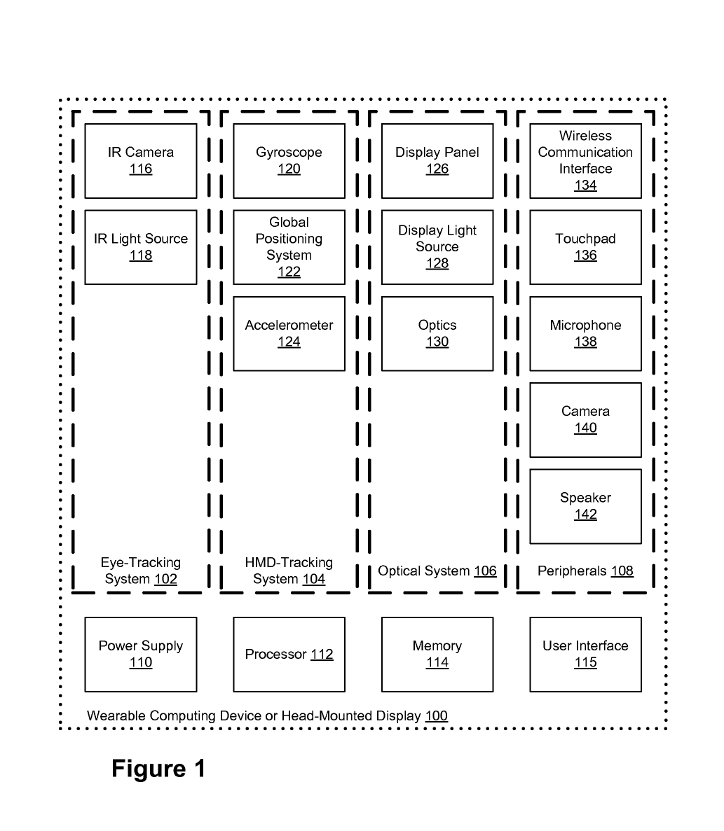

FIG. 1 is a schematic diagram of a wearable computing device or a head-mounted display (HMD) 100 that may include several different components and subsystems. As shown, the HMD 100 includes an eye-tracking system 102, a HMD-tracking system 104, an optical system 106, peripherals 108, a power supply 110, a processor 112, a memory 114, and a user interface 115. The eye-tracking system 102 may include hardware such as at least one infrared camera 116 and at least one infrared light source 118. The HMD-tracking system 104 may include a gyroscope 120, a global positioning system (GPS) 122, and an accelerometer 124. The optical system 106 may include, in one embodiment, a display panel 126, a display light source 128, and optics 130. The peripherals 108 may include a wireless communication interface 134, a touchpad 136, a microphone 138, a camera 140, and a speaker 142.

In an example embodiment, HMD 100 includes a see-through display. Thus, the wearer of HMD 100 may observe a portion of the real-world environment, i.e., in a particular field of view provided by the optical system 106. In the example embodiment, HMD 100 is operable to display images that are superimposed on the field of view, for example, to provide an “augmented reality” experience. Some of the images displayed by HMD 100 may be superimposed over particular objects in the field of view. HMD 100 may also display images that appear to hover within the field of view instead of being associated with particular objects in the field of view.

Components of the HMD 100 may be configured to work in an interconnected fashion with other components within or outside their respective systems. For instance, in an example embodiment, at least one infrared camera 116 may image one or both of the HMD wearer's eyes. The infrared camera 116 may deliver image information to the processor 112, which may access the memory 114 and make a determination regarding the gaze axis (or axes) of the HMD wearer's eye(s). The processor 112 may subsequently determine a vergence angle that could establish, for instance, the gaze depth of the HMD wearer. The processor 112 may further accept input from the GPS unit 122, the gyroscope 120, and/or the accelerometer 124 to determine the location and orientation of the HMD 100. Subsequently, the processor 112 may control the user interface 115 and the display panel 126 to display images to the HMD wearer that may include context-specific information based on the HMD location and orientation as well as the HMD wearer's vergence angle.

HMD 100 could be configured as, for example, eyeglasses, goggles, a helmet, a hat, a visor, a headband, or in some other form that can be supported on or from the wearer's head. Further, HMD 100 may be configured to display images to both of the wearer's eyes, for example, using two see-through displays. Alternatively, HMD 100 may include only a single see-through display and may display images to only one of the wearer's eyes, either the left eye or the right eye.

The HMD 100 may also represent an opaque display configured to display images to one or both of the wearer's eyes without a view of the real-world environment. For instance, an opaque display or displays could provide images to both of the wearer's eyes such that the wearer could experience a virtual reality version of the real world. Alternatively, the HMD wearer may experience an abstract virtual reality environment that could be substantially or completely detached from the real world. Further, the HMD 100 could provide an opaque display for a first eye of the wearer as well as provide a view of the real-world environment for a second eye of the wearer.

A power supply 110 may provide power to various HMD components and could represent, for example, a rechargeable lithium-ion battery. Various other power supply materials and types known in the art are possible.

The functioning of the HMD 100 may be controlled by a processor 112 that executes instructions stored in a non-transitory computer readable medium, such as the memory 114. Thus, the processor 112 in combination with instructions stored in the memory 114 may function as a controller of HMD 100. As such, the processor 112 may control the user interface 115 to adjust the images displayed by HMD 100. The processor 112 may also control the wireless communication interface 134 and various other components of the HMD 100. The processor 112 may additionally represent a plurality of computing devices that may serve to control individual components or subsystems of the HMD 100 in a distributed fashion.

In addition to instructions that may be executed by the processor 112, the memory 114 may store data that may include a set of calibrated wearer eye pupil positions and a collection of past eye pupil positions. Thus, the memory 114 may function as a database of information related to gaze direction. Such information may be used by HMD 100 to anticipate where the user will look and determine what images are to be displayed to the wearer. Calibrated wearer eye pupil positions may include, for instance, information regarding the extents or range of the wearer's eye pupil movement (right/left and upwards/downwards) as well as wearer eye pupil positions that may relate to various reference axes.

Reference axes could represent, for example, an axis extending from a viewing location and through a target object or the apparent center of a field of view (i.e. a central axis that may project through a center point of the apparent display panel of the HMD). Other possibilities for reference axes exist. Thus, a reference axis may further represent a basis for determining dynamic gaze direction.

In addition, information may be stored in the memory 114 regarding possible control instructions that may be enacted using eye movements. For instance, two consecutive wearer eye blinks may represent a control instruction directing the HMD 100 to capture an image using camera 140. Another possible embodiment may include a configuration such that specific eye movements may represent a control instruction. For example, a HMD wearer may lock or unlock the user interface 115 with a series of predetermined eye movements.

Control instructions could be based on dwell-based selection of a target object. For instance, if a wearer fixates visually upon a particular displayed image or real-world object for longer than a predetermined time period, a control instruction may be generated to select the displayed image or real-world object as a target object. Many other control instructions are possible.

The HMD 100 may include a user interface 115 for providing information to the wearer or receiving input from the wearer. The user interface 115 could be associated with, for example, the displayed images and/or one or more input devices in peripherals 108, such as touchpad 136 or microphone 138. The processor 112 may control the functioning of the HMD 100 based on inputs received through the user interface 115. For example, the processor 112 may utilize user input from the user interface 115 to control how the HMD 100 displays images within a field of view or to determine what images the HMD 100 displays.

An eye-tracking system 102 may be included in the HMD 100. In an example embodiment, an eye-tracking system 102 may deliver information to the processor 112 regarding the eye position of a wearer of the HMD 100. The eye-tracking data could be used, for instance, to determine a direction in which the HMD wearer may be gazing. The processor 112 could determine target objects among the displayed images based on information from the eye-tracking system 102. The processor 112 may control the user interface 115 and the display panel 126 to adjust the target object and/or other displayed images in various ways. For instance, a HMD wearer could interact with a mobile-type menu-driven user interface using eye gaze movements.

The infrared camera 116 may be utilized by the eye-tracking system 102 to capture images of a viewing location associated with the HMD 100. Thus, the infrared camera 116 may image the eye of a HMD wearer that may be located at the viewing location. The images could be either video images or still images. The images obtained by the infrared camera 116 regarding the HMD wearer's eye may help determine where the wearer is looking within the HMD field of view, for instance by allowing the processor 112 to ascertain the location of the HMD wearer's eye pupil. Analysis of the images obtained by the infrared camera 116 could be performed by the processor 112 in conjunction with the memory 114 to determine, for example, a gaze direction.

The imaging of the viewing location could occur continuously or at discrete times depending upon, for instance, user interactions with the user interface 115 and/or the state of the infrared light source 118 which may serve to illuminate the viewing location. The infrared camera 116 could be integrated into the optical system 106 or mounted on the HMD 100. Alternatively, the infrared camera could be positioned apart from the HMD 100 altogether. Furthermore, the infrared camera 116 could additionally represent a conventional visible light camera with sensing capabilities in the infrared wavelengths. The infrared camera 116 could be operated at video rate frequency (e.g. 60 Hz) or a multiple of video rates (e.g. 240 Hz), which may be more amenable to combining multiple frames while determining a gaze direction.

The infrared light source 118 could represent one or more infrared light-emitting diodes (LEDs) or infrared laser diodes that may illuminate a viewing location. One or both eyes of a wearer of the HMD 100 may be illuminated by the infrared light source 118. The infrared light source 118 may be positioned along an optical axis common to the infrared camera, and/or the infrared light source 118 may be positioned elsewhere. The infrared light source 118 may illuminate the viewing location continuously or may be turned on at discrete times. Additionally, when illuminated, the infrared light source 118 may be modulated at a particular frequency. Other types of modulation of the infrared light source 118, such as adjusting the intensity level of the infrared light source 118, are possible.

The eye-tracking system 102 could be configured to acquire images of glint reflections from the outer surface of the cornea, which are also called first Purkinje images. Alternatively, the eye-tracking system 102 could be configured to acquire images of reflections from the inner, posterior surface of the lens, which are termed fourth Purkinje images. In yet another embodiment, the eye-tracking system 102 could be configured to acquire images of the eye pupil with so-called bright and/or dark pupil images. In practice, a combination of these glint and pupil imaging techniques may be used for rotational eye tracking, accuracy, and redundancy. Other imaging and tracking methods are possible. Those knowledgeable in the art will understand that there are several alternative ways to achieve eye tracking with a combination of infrared illuminator and camera hardware.

The locations of both eyes could be determined optically and/or inferred based on other information in order to determine respective gaze axes and the corresponding vergence angle between the axes. Accordingly, at least one eye-tracking system 102 may be utilized with one or more infrared cameras 116 and one or more infrared light sources 118 in order to track the position of one eye or both eyes of the HMD wearer.

The HMD-tracking system 104 could be configured to provide a HMD position and a HMD orientation to the processor 112. This position and orientation data may help determine a central axis to which a gaze direction is compared. For instance, the central axis may correspond to the orientation of the HMD.

The gyroscope 120 could be a microelectromechanical system (MEMS) gyroscope, a fiber optic gyroscope, or another type of gyroscope known in the art. The gyroscope 120 may be configured to provide orientation information to the processor 112. The GPS unit 122 could be a receiver that obtains clock and other signals from GPS satellites and may be configured to provide real-time location information to the processor 112. The HMD-tracking system 104 could further include an accelerometer 124 configured to provide motion input data to the processor 112.

The optical system 106 could include components configured to provide images at a viewing location. The viewing location may correspond to the location of one or both eyes of a wearer of a HMD 100. The components could include a display panel 126, a display light source 128, and optics 130. These components may be optically and/or electrically-coupled to one another and may be configured to provide viewable images at a viewing location. As mentioned above, one or two optical systems 106 could be provided in a HMD apparatus. In other words, the HMD wearer could view images in one or both eyes, as provided by one or more optical systems 106. Also, as described above, the optical system(s) 106 could include an opaque display and/or a see-through display, which may allow a view of the real-world environment while providing superimposed images.

Various peripheral devices 108 may be included in the HMD 100 and may serve to provide information to and from a wearer of the HMD 100. In one example, the HMD 100 may include a wireless communication interface 134 for wirelessly communicating with one or more devices directly or via a communication network. For example, the wireless communication interface 134 could use 3G cellular communication, such as CDMA, EVDO, GSM/GPRS, or 4G cellular communication, such as WiMAX or LTE. Alternatively, the wireless communication interface 134 could communicate with a wireless local area network (WLAN), for example, using WiFi. In some embodiments, the wireless communication interface 134 could communicate directly with a device, for example, using an infrared link, Bluetooth, or ZigBee. The wireless communication interface 134 could interact with devices that may include, for example, components of the HMD 100 and/or externally-located devices.

Although FIG. 1 shows various components of the HMD 100 (i.e., wireless communication interface 134, processor 112, memory 114, infrared camera 116, display panel 126, GPS 122, and user interface 115) as being integrated into HMD 100, one or more of these components could be physically separate from HMD 100. For example, the infrared camera 116 could be mounted on the wearer separate from HMD 100. Thus, the HMD 100 could be part of a wearable computing device in the form of separate devices that can be worn on or carried by the wearer. The separate components that make up the wearable computing device could be communicatively coupled together in either a wired or wireless fashion.

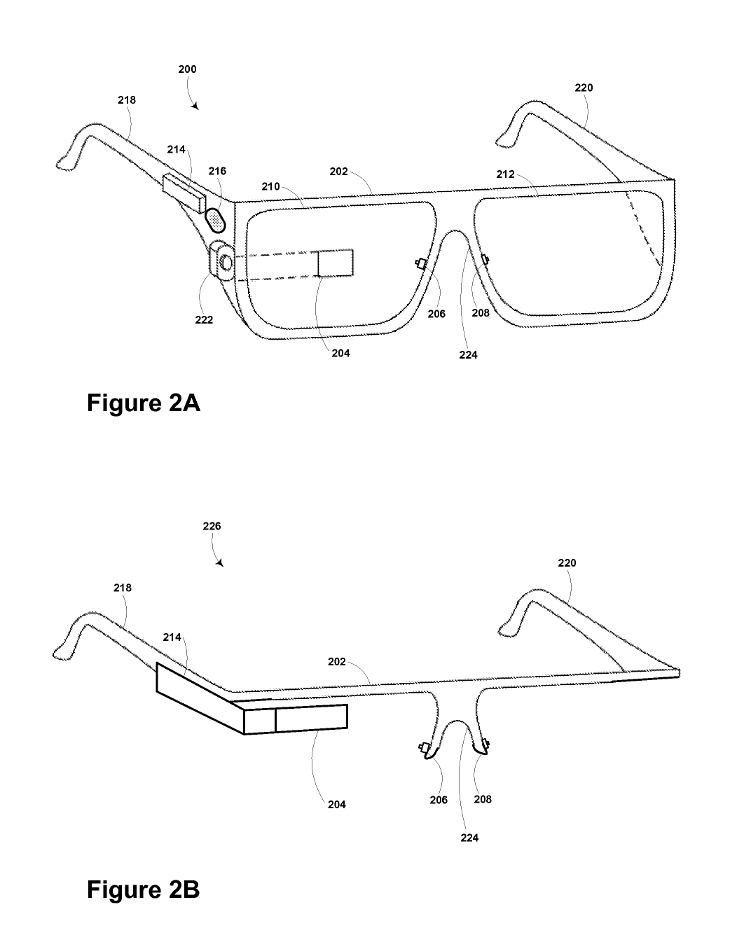

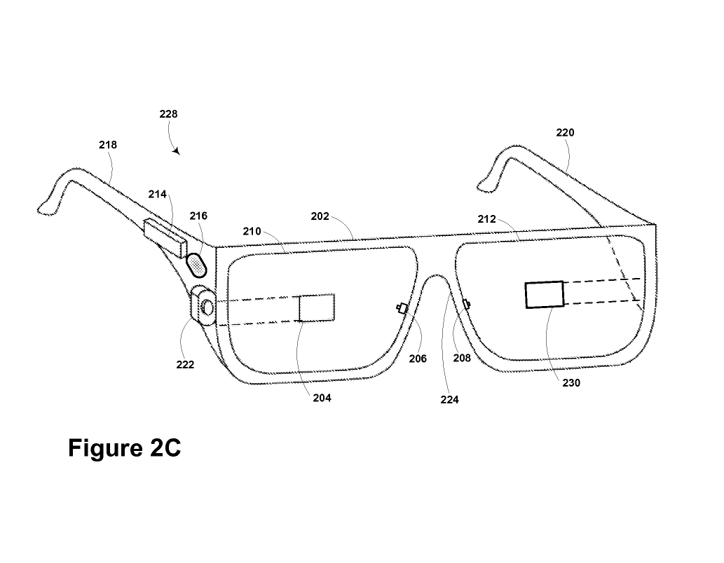

FIGS. 2A and 2B illustrate two of many possible embodiments involving head-mounted displays with gaze axis vergence determination. In general, the example systems could be used to receive, transmit, and display data. In one embodiment, the HMD 200 may have a glasses format. As illustrated in FIG. 2A, the HMD 200 has a frame 202 that could include nosepiece 224 and earpieces 218 and 220. The frame 202, nosepiece 224, and earpieces 218 and 220 could be configured to secure the HMD 200 to a user's face via a user's nose and ears. Each of the frame elements, 202, 224, and 218 may be formed of a solid structure of plastic and/or metal, or may be formed of a hollow structure of similar material so as to allow wiring and component interconnects to be internally routed through the HMD 200. Other materials may be possible as well.

The earpieces 218 and 220 could be attached to projections that extend away from the lens frame 202 and could be positioned behind a user's ears to secure the HMD 200 to the user. The projections could further secure the HMD 200 to the user by extending around a rear portion of the user's head. Additionally or alternatively, for example, the HMD 200 could connect to or be affixed within a head-mounted helmet structure. Other possibilities exist as well.

Lens elements 210 and 212 could be mounted in frame 202. The lens elements 210 and 212 could be formed of any material that can suitably display a projected image or graphic. Each of the lens elements 210 and 212 could be sufficiently transparent to allow a user to see through the lens element. Combining these two features of the lens elements may facilitate an augmented reality or a heads-up display where the projected image or graphic is superimposed over a real-world view as perceived by the user through lens elements 210 and 212.

The HMD 200 may include a computer 214, a touch pad 216, a camera 222, and a display 204. The computer 214 is shown to be positioned on the extending side arm of the HMD 200; however, the computer 214 may be provided on other parts of the HMD 200 or may be positioned remote from the HMD 200 (e.g. the computer 214 could be wire- or wirelessly-connected to the HMD 200). The computer 214 could include a processor and memory, for example. The computer 214 may be configured to receive and analyze data from the camera 222 and the touch pad 216 (and possibly from other sensory devices, user-interfaces, or both) and generate images for output by the lens elements 210 and 212.

A camera 222 could be positioned on an extending side arm of the HMD 200, however, the camera 222 may be provided on other parts of the HMD 200. The camera 222 may be configured to capture images at various resolutions or at different frame rates. The camera 222 could be configured as a video camera and/or as a still camera. A camera with small form factor, such as those used in cell phones or webcams, for example, may be incorporated into an example embodiment of HMD 200.

Further, although FIG. 2A illustrates one camera 222, more cameras could be used, and each may be configured to capture the same view, or to capture different views. For example camera 222 may be forward facing to capture at least a portion of the real-world view perceived by the user. This forward facing image captured by the camera 222 may then be used to generate an augmented reality where computer generated images appear to interact with the real world view perceived by the user.

Other sensors could be incorporated into HMD 200. Other sensors may include one or more of a gyroscope or an accelerometer, for example. Other sensing devices may be included in HMD 200.

The touch pad 216 is shown on an extending side arm of the HMD 200. However, the touch pad 216 may be positioned on other parts of the HMD 200. Also, more than one touch pad may be present on the HMD 200. The touch pad 216 may be used by a user to input commands. The touch pad 216 may sense at least one of a position and a movement of a finger via capacitive sensing, resistance sensing, or a surface acoustic wave process, among other possibilities. The touch pad 216 may be capable of sensing finger movement in a direction parallel or planar to the pad surface, in a direction normal to the pad surface, or both, and may also be capable of sensing a level of pressure applied to the pad surface. The touch pad 216 may be formed of one or more translucent or transparent insulating layers and one or more translucent or transparent conducting layers. Edges of the touch pad 216 may be formed to have a raised, indented, or roughened surface, so as to provide tactile feedback to a user when the user's finger reaches the edge, or other area, of the touch pad 216. If more than one touch pad is present, each touch pad may be operated independently, and may provide a different function.

Additionally, the HMD 200 may include eye-tracking systems 206 and 208, which may be configured to track the eye position of each eye of the HMD wearer. The eye-tracking systems 206 and 208 may each include one or more infrared light sources and one or more infrared cameras. Each of the eye-tracking systems 206 and 208 could be configured to image one or both of the HMD wearer's eyes. Although two eye-tracking systems are depicted in FIG. 2A, other embodiments are possible. For instance, one eye-tracking system could be used to track both eyes of a user.

Display 204 could represent, for instance, an at least partially reflective surface upon which images could be projected using a projector. The lens elements 210 and 212 could act as a combiner in a light projection system and may include a coating that reflects the light projected onto them from projectors. In some embodiments, a reflective coating may not be used (e.g. when the projectors are scanning laser devices). The images could be thus viewable to a HMD user.

Although the display 204 is depicted as presented to the right eye of the HMD wearer, other example embodiments could include a display for both eyes or a single display viewable by both eyes.

In alternative embodiments, other types of display elements may be used. For example, the lens elements 210 and 212 could themselves include: a transparent or semi-transparent matrix display, such as an electroluminescent display or a liquid crystal display, one or more waveguides for delivering an image to the user's eyes, or other optical elements capable of delivering an in focus near-to-eye image to the user. A corresponding display driver may be disposed within the frame 202 for driving such a matrix display. Alternatively or additionally, a laser or light-emitting diode (LED) source and scanning system could be used to draw a raster display directly onto the retina of one or more of the user's eyes. Other possibilities exist as well.

In FIG. 2B, a HMD 226 with monocle design is illustrated. The HMD frame 202 could include nosepiece 224 and earpieces 218 and 220. The HMD 226 may include a single display 204 that may be coupled to one of the side arms or the nose piece 224. In one example, the single display 204 could be coupled to the inner side (i.e. the side exposed to a portion of a user's head when worn by the user) of the extending side arm of frame 202. The display 204 could be positioned in front of or proximate to a user's eye when the HMD 200 is worn by a user. The display 204 could be configured to overlay computer-generated graphics upon the user's view of the physical world.

As in the aforementioned embodiments, eye-tracking systems 206 and 208 could be mounted on nosepiece 224. The eye-tracking systems 206 and 208 could be configured to track the eye position of both eyes of a HMD wearer. The HMD 226 could include a computer 214 and a display 204 for one eye of the HMD wearer.

FIG. 2C illustrates a HMD 228 with a binocular design. In such an embodiment, separate displays could be provided for each eye of a HMD user. For example, displays 204 and 230 could be provided to the right and left eye of the HMD user, respectively. Alternatively, a single display could provide images to both eyes of the HMD user. The images provided to each eye may be different or identical to one another. Further, the images could be provided to each eye in an effort to create a stereoscopic illusion of depth.

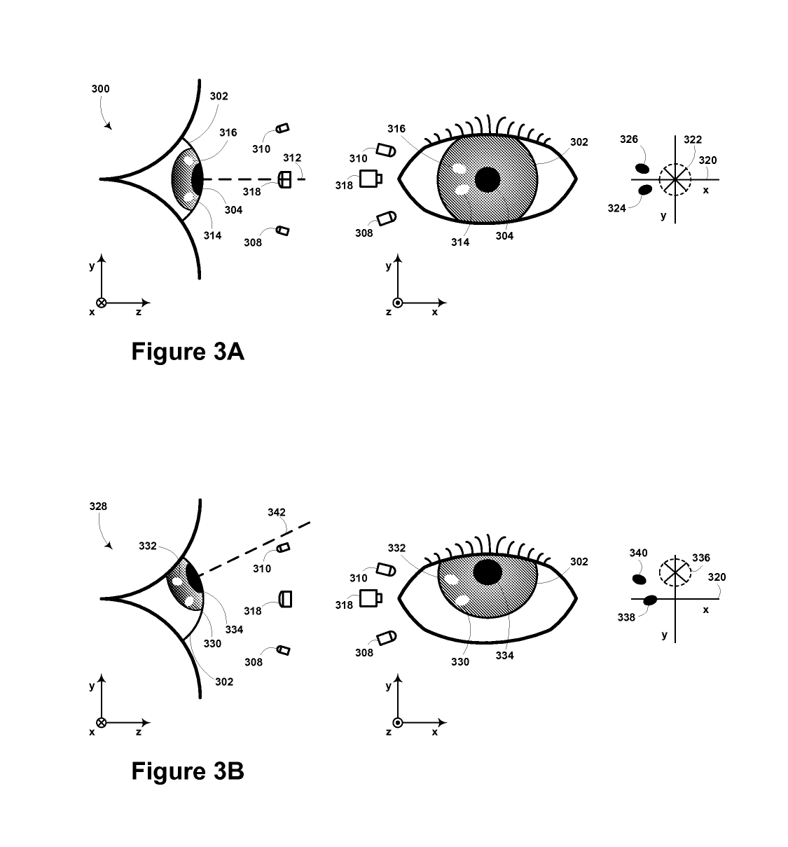

FIGS. 3A and 3B are side and front views of an eye of a HMD user gazing forward and gazing upward, respectively. In the former scenario, when a HMD user may be gazing forward 300, light sources 308 and 310 could be configured to illuminate the HMD user's eye 302. Glint reflections 314 and 316 from the HMD user's eye 302 could be generated based on the illumination from the light sources 308 and 310. These glint reflections 314 and 316 could be first Purkinje images from reflections from the outer surface of the HMD user's cornea. The glint reflections 314 and 316 as well as the eye pupil 304 could be imaged by a camera 318. Images could be sent to a processor that may, in turn, analyze the glint locations 324 and 326 with respect to a coordinate system 320 in order to determine and/or confirm a pupil location 322. In the case where the HMD user may be gazing forward, the pupil location may be determined to be near the center of the reference coordinate system 320. Accordingly, a gaze direction 312 may be determined to be straight ahead. A gaze point may be determined to be at a point along the gaze direction 312.

FIG. 3B depicts a scenario 328 where a HMD user is gazing upward. Similar to the aforementioned example, light sources 308 and 310 could induce respective glint reflections 330 and 332 from the HMD user's eye 302. In this scenario, however, the glint reflections 330 and 332 may appear in different locations due to the change in the eye gaze direction of the HMD wearer and asymmetry of the shape of the eye 302. Thus glint reflections 338 and 340 may move with respect to reference coordinate system 320. Image analysis could be used to determine the pupil location 336 within the reference coordinate system 320. From the pupil location 336, a gaze direction 342 may be determined. A gaze point could be determined as a point along the gaze direction 342.

In some embodiments, gaze directions could be optically determined for both eyes, for example, as described above for FIGS. 3A and 3B. The gaze directions from both eyes could be used to find a vergence angle in a determination of where the user may be gazing. In other embodiments, a gaze direction could be optically determined for only one eye, and the gaze direction for the other eye could be inferred. The vergence angle could be determined based on the optically-determined gaze direction and the inferred gaze direction.

A gaze direction could be inferred from head movements. For example, because of the head's natural tendency to keep the eyes centered (i.e., the head lags behind the eyes, but tends to “frame” the subject), it is possible to look for eye fixations that cluster around a certain point (converting fixations into gaze points), and then use other sensors (e.g., one or more of the sensors in HMD-tracking system 104) to detect movement of the head. When that head movement ceases, but the optically-tracked eye remains off-center in one direction, it is possible to infer that the other eye is similarly off-center in the other direction. This is because this pattern of head movements can be indicative of the person's eyes converging on a nearby object, with the person's head “framing” the nearby object. In that configuration, the gaze directions of both eyes would be at the same angle from the forward direction (defined by the position of the person's head) but from opposite sides.

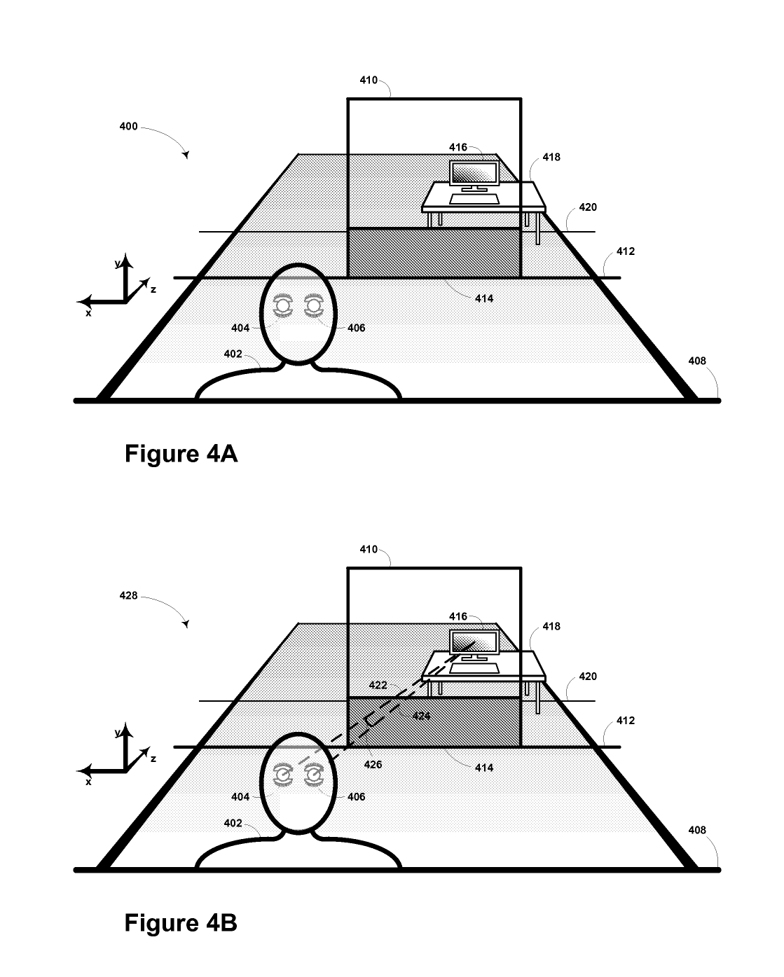

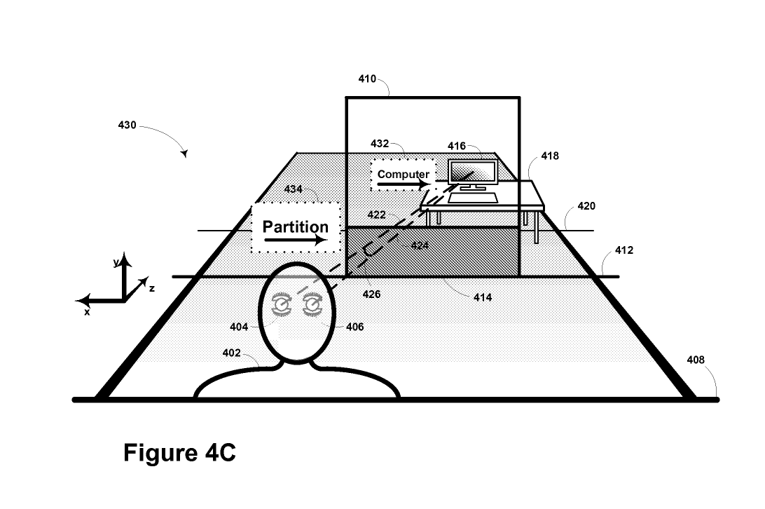

FIGS. 4A, 4B, and 4C illustrate scenarios in which the aforementioned system could be applied. In scenario 400, a HMD wearer 402 with first and second eyes (404 and 406) could be in a real-world environment with a partition that may include a wall portion 414 and a glass portion 410. Beyond the partition, a computer monitor 416 may be viewable through the glass portion 410. The computer monitor 416 could be located on a desk 418. The partition and the computer monitor 416 could be located at a first depth plane 412 and a second depth plane 420, with respect to a HMD wearer plane 408.

In FIG. 4B, a HMD wearer may be looking at the computer monitor 416 (scenario 428). The eye-tracking data from both eyes of the HMD wearer may allow the processor 112 to determine gaze axes 422 and 424. A corresponding vergence angle 426 could be determined. Based on vergence angle 426, processor 112 may determine that the HMD wearer is gazing at the computer monitor 416.

As mentioned above, the determination of a vergence angle may help to disambiguate an actual target object from a set of candidate target objects. In scenario 428, the actual target object may be ambiguous if eye-tracking data from only one eye is used or if only HMD-tracking data is used. In either case, it may be unclear whether the HMD wearer is gazing at the glass portion 410 of the partition, the computer monitor 416, or any other object along the single gaze axis. Thus, the vergence angle 426 of the gaze axes 422 and 424 may reduce the uncertainty of object selection.

FIG. 4C illustrates how various notifications may be generated upon vergence angle determination. As described above, FIG. 4C depicts a HMD wearer 402 with first and second eyes (404 and 406). The HMD wearer could be in a real-world environment that includes a partition that may include a wall portion 414 and a glass portion 410. Beyond the partition, a computer monitor 416 may be viewable through the glass portion 410. The computer monitor 416 could be located on a desk 418. The partition and the computer monitor 416 could be located at a first depth plane 412 and a second depth plane 420, respectively.

When the vergence angle of the scenario 430 is determined, the system may determine that the HMD wearer is gazing at the computer monitor 416. Accordingly, notifications in the form of images could be generated. An image message 434 that states, “Partition” could help alert the HMD wearer not to run into it when walking, for instance. A notification 432 that states, “Computer” could help further identify the object at which the HMD wearer is gazing. Other target object-dependent notification messages are possible.

As stated above, the effective distances for determining gaze point using vergence angle may be up to around 3 meters. Therefore, the following methods may be useful in close- to mid-range interactions such as the aforementioned office example. In long range situations (greater than 3 meters), vergence may be a less useful way to determine gaze depth and/or to select target objects.

3. Method for Target Object Selection Using Eye Tracking and Vergence Angle Determination

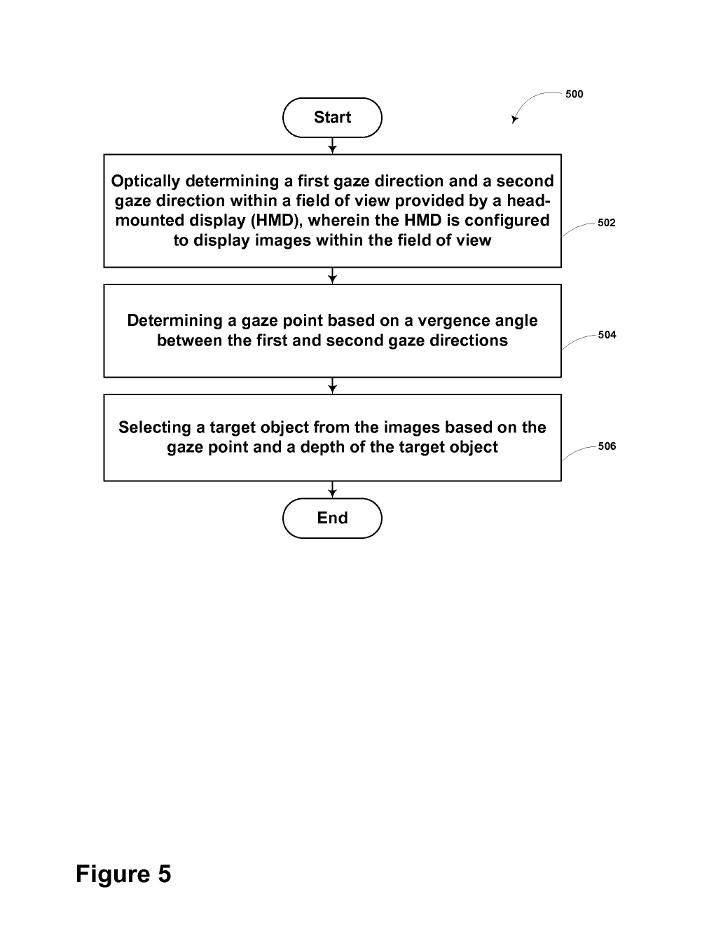

A method 500 is provided for selecting target objects by determining the vergence angle between the gaze axes of the eyes of a HMD wearer. The method could be performed using an apparatus shown in FIGS. 1-4C and as described above, however, other configurations could be used. FIG. 5 illustrates the steps in an example method, however, it is understood that in other embodiments, the steps may appear in different order and steps may be added or subtracted.

Method step 502 includes optically determining a first gaze direction and a second gaze direction within a field of view provided by a head-mounted display (HMD). The HMD is configured to display images within the field of view. The first and second gaze directions could represent the gaze axis of each eye of a HMD wearer. The first and second gaze directions could be optically determined using various apparatuses known in the art including the eye-tracking system described above. The HMD may include at least one display configured to generate images viewable to one or both eyes of the HMD wearer.

Method step 504 includes determining a gaze point based on the vergence angle between the first and second gaze directions. The vergence angle is the angle created when the first and second gaze directions intersect, for instance when the HMD wearer is looking at a nearby object. In general, the vergence angle may strongly indicate the point at which the HMD wearer is gazing. Thus, by tracking the eye position of both eyes of a HMD wearer, a vergence angle can be determined. Accordingly, a gaze point may be determined from the vergence angle using basic geometric methods.

Method step 506 includes selecting a target object from the images based on the gaze point and the depth of the target object. The selected target object could have a similar or identical depth as the gaze point. Further, the selected target object could be any member of the set of images displayed by the HMD. The target object selection could be performed immediately upon determination of a gaze point/target object location match, or could take place after a predetermined period of time. For instance, the target object selection could happen once a HMD wearer stares at an image for 500 milliseconds.

### 4. Method for Image Adjustment Using Eye Tracking and Vergence Angle Determination

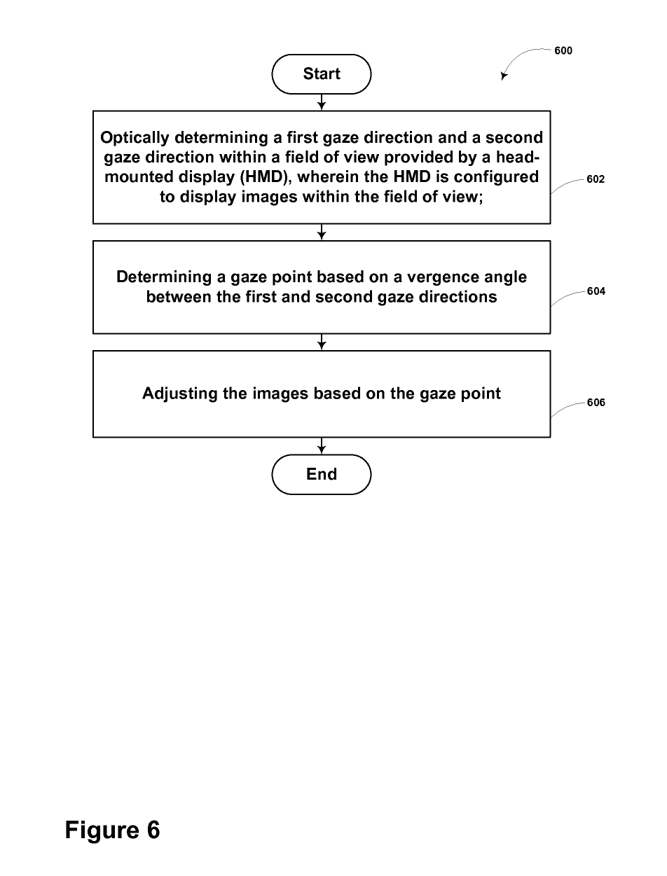

A method 600 is provided for adjusting images based on a gaze point, which can be determined from a vergence angle between the gaze axes of the eyes of a head-mounted display (HMD) wearer. The method could be performed using an apparatus shown in FIGS. 1-4C and as described above, however, other configurations could be used. FIG. 6 illustrates the steps in an example method, however, it is understood that in other embodiments, the steps may appear in different order and steps may be added or subtracted.

The first two steps of method 600 (steps 602 and 604) could be similar or identical to the corresponding steps of method 500. In other words, an eye-tracking system or other optical means could be utilized to determine a first gaze direction and a second gaze direction within a field of view of the HMD (step 602). A gaze point may then be determined based on the vergence angle between the first and second gaze directions (step 604).

In a third method step 606, images displayed in the field of view for the HMD could be adjusted based on the determined gaze point. The determined gaze point could relate to a target object that could include real-world objects or displayed images. The adjusted images could include any graphical or text element displayed by the HMD. For instance, the eye-tracking system could determine that a HMD wearer is gazing at a computer screen based on the vergence angle of his or her eyes. Correspondingly, images (such as icons or other notifications) could be adjusted away from the gaze location so as to allow an unobstructed view of the real-world object. The images could be adjusted dynamically, or, for instance, only when a new, contextually-important gaze point is determined.

In another embodiment, upon recognition that a HMD wearer is gazing at a target object, an image could be displayed that provides information about the target object. In the case that a HMD wearer is gazing at a computer screen in the real-world environment, a notification may be generated. The notification could take the form of an image viewable to the HMD wearer as apparently adjacent to the computer screen. The notification could include specific information about the computer such as machine owner, model number, operating state, etc. Other notification types and content are possible.

### 5. A Non-Transitory Computer Readable Medium for Target Object Selection Using Eye Tracking and Vergence Angle Determination

Some or all of the functions described above in method 500, method 600 and illustrated in FIGS. 3A, 3B, 4A, 4B, and 4C, may be performed by a computing device in response to the execution of instructions stored in a non-transitory computer readable medium. The non-transitory computer readable medium could be, for example, a random access memory (RAM), a read-only memory (ROM), a flash memory, a cache memory, one or more magnetically encoded discs, one or more optically encoded discs, or any other form of non-transitory data storage. The non-transitory computer readable medium could also be distributed among multiple data storage elements, which could be remotely located from each other. The computing device that executes the stored instructions could be a wearable computing device, such as a wearable computing device 100 illustrated in FIG. 1. Alternatively, the computing device that executes the stored instructions could be another computing device, such as a server in a server network. A non-transitory computer readable medium may store instructions executable by the processor 112 to perform various functions.

For instance, instructions that could be used to carry out method 500 may be stored in memory 114 and could be executed by processor 112. In such an embodiment, upon receiving gaze information from the eye-tracking system 102, the processor 112 may carry out instructions to determine a gaze axis for both eyes of a user. Accordingly, a vergence angle may be calculated. Based on at least the determined vergence angle, a target object may be selected from the set of displayed images.

Those with skill in the art will understand that many other instructions may be stored by a non-transitory computer readable medium that may relate to the determination of a vergence angle to enhance and/or modify interactions with real world objects and/or displayed images. These other examples are implicitly considered herein.

### CONCLUSION

The above detailed description describes various features and functions of the disclosed systems, devices, and methods with reference to the accompanying figures. While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

What is claimed is:

1. A wearable computing device, comprising:
a head-mounted display (HMD), wherein the HMD is configured to display images, wherein the images are viewable from at least one of a first viewing location or a second viewing location;
at least one infrared light source, wherein the at least one infrared light source is configured to illuminate at least one of the first viewing location or the second viewing location with infrared light such that the infrared light is reflected from the at least one illuminated viewing location as reflected infrared light;
at least one camera, wherein the at least one camera is configured to acquire at least one image of the at least one illuminated viewing location by collecting the reflected infrared light; and
a computer, wherein the computer is configured to determine a vergence angle based on the at least one image of the at least one illuminated viewing location, determine a gaze point based on the vergence angle, select an image based on the gaze point, and control the HMD to display the selected image.

2. The wearable computing device of claim 1, wherein the HMD comprises a see-through display.

3. The wearable computing device of claim 1, wherein the HMD comprises a binocular display.

4. The wearable computing device of claim 1, wherein the HMD comprises a monocular display.

5. The wearable computing device of claim 1, wherein the at least one camera is mounted on the HMD.

6. The wearable computing device of claim 1, wherein the at least one infrared light source is an infrared light-emitting diode (LED).

7. The wearable computing device of claim 1, wherein the at least one infrared light source is mounted on the HMD.

8. The wearable computing device of claim 1, wherein the at least one camera is an infrared camera.

9. A method, comprising:
optically determining a first gaze direction and a second gaze direction within a field of view provided by a head-mounted display (HMD), wherein the HMD is configured to display images within the field of view;
determining a gaze point based on a vergence angle between the first and second gaze directions; and
selecting a target object from the images based on the gaze point and a depth of the target object.

10. The method of claim 9, wherein optically determining a first and second gaze direction comprises:
obtaining at least one image of each eye of a wearer of the HMD; and
determining the first and second gaze direction from the at least one image of each eye.

11. The method of claim 10, wherein obtaining at least one image of each eye of a wearer of the HMD comprises illuminating each eye with an infrared light source and imaging each eye with a camera.

12. The method of claim 9, wherein determining a gaze point comprises determining an intersection of the first and second gaze directions and determining a gaze point based on the intersection and an HMD position.

13. A method, comprising:
optically determining a first gaze direction and a second gaze direction within a field of view provided by a head-mounted display (HMD), wherein the HMD is configured to display images within the field of view;
determining a gaze point based on a vergence angle between the first and second gaze directions; and
adjusting the images based on the gaze point.

14. The method of claim 13, wherein optically determining a first and second gaze direction comprises:
obtaining at least one image of each eye of a wearer of the HMD; and
determining the first and second gaze direction from the at least one image of each eye.

15. The method of claim 14, wherein obtaining at least one image of each eye of a wearer of the HMD comprises illuminating each eye with an infrared light source and imaging each eye with a camera.

16. The method of claim 13, wherein determining a gaze point comprises determining an intersection of the first and second gaze directions and determining a gaze point based on the intersection and an HMD position.

17. A non-transitory computer readable medium having stored therein instructions executable by a computing device to cause the computing device to perform functions comprising:
causing a head-mounted display (HMD) to acquire images of first and second viewing locations, wherein the HMD is configured to display images;
determining a first gaze direction and a second gaze direction based on the images of the first and second viewing locations;
determining a gaze point based on a vergence angle between the first and second gaze directions; and
selecting a target object from the images based on the gaze point and a depth of the target object.

18. The non-transitory computer readable medium of claim 17, wherein causing the HMD to acquire images of first and second viewing locations comprises acquiring at least one image of each eye of a wearer of the HMD

19. The non-transitory computer readable medium of claim 18, wherein acquiring at least one image of each eye of a wearer of the HMD comprises illuminating each eye with an infrared source and imaging each eye with a camera.

20. The non-transitory computer readable medium of claim 17, wherein determining a gaze point further comprises determining an intersection of the first and second gaze directions and determining a gaze point based on the intersection and an HMD position.
